(19) United States
(12) Patent Application Publication
(10) Pub. No.: US 2020/0121424 A1
(43) Pub. Date: Apr. 23, 2020

(54) METHODS AND SYSTEMS FOR MOVING TEETH

(71) Applicant: Hui Feng, Shanghai (CN)

(72) Inventor: Hui Feng, Shanghai (CN)

(21) Appl. No.: 16/657,694

(22) Filed: Oct. 18, 2019

Related U.S. Application Data
(60) Provisional application No. 62/747,395, filed on Oct. 18, 2018.

(51) Int. Cl. A61C 7/08

(52) U.S. Cl. CPC A61C 7/08

(57) ABSTRACT

Provided herein is system for repositioning teeth of a user in need thereof from an initial tooth arrangement to a final tooth arrangement, the user having a dental arch that comprises malpositioned teeth and normal-positioned teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement, each of the one or more intermediate appliances having at least one identical copy; and (c) at least one final appliance having a geometry selected to progressively reposition the teeth from the initial tooth arrangement or the last intermediate arrangement to the final tooth arrangement.

### CROSS-REFERENCE TO RELATED APPLICATIONS

This application claims the benefit of U.S. provisional application Ser. No. 62/747,395, filed Oct. 18, 2018, the teaching of which being incorporated herein by reference in its entirety.

### FIELD OF THE INVENTION

The present invention is related generally to the field of orthodontics.

### BACKGROUND OF THE INVENTION

Conventional method of repositioning teeth is to make users wear what are commonly referred to as “braces.” Braces include a variety of appliances such as brackets, archwires, ligatures, and O-rings. The procedures of conventional orthodontics are briefly described here: Before fastening braces to a user's teeth, at least one appointment is typically scheduled with the orthodontist, dentist, and/or X-ray laboratory so that X-rays and photographs of the user's teeth and jaw structure can be taken. Also during this preliminary meeting, or possibly at a later meeting, an alginate mold of the user's teeth is typically made. This mold provides a model of the user's teeth that the orthodontist uses in conjunction with the X-rays and photographs to formulate a treatment strategy. The orthodontist then typically schedules one or more appointments during which braces will be attached to the user's teeth.

At the meeting during which braces are first attached, the teeth surfaces are initially treated with a weak acid the acid optimizes the adhesion properties of the teeth surfaces for brackets and bands that are to be bonded to them. The brackets and bands serve as anchors for other appliances to be added later. After the acid step, the brackets and bands are cemented to the user's teeth using a suitable bonding material. No force-inducing appliances are added until the cement is set. For this reason, it is common for the orthodontist to schedule a later appointment to ensure that the brackets and bands are well bonded to the teeth.

The primary force-inducing appliance in a conventional set of braces is the archwire. The archwire is resilient and is attached to the brackets by way of slots in the brackets. The archwire links the brackets together and exerts forces on them to move the teeth over time. Twisted wires or elastomeric O-rings are commonly used to reinforce attachment of the archwire to the brackets. Attachment of the archwire to the brackets is known in the art of orthodontia as “ligation” and wires used in this procedure are called “ligatures.” The elastomeric O-rings are called “plastics.”

After the archwire is in place, periodic meetings with the orthodontist are required, during which the user's braces will be adjusted by installing a different archwire having different force inducing properties or by replacing or tightening existing ligatures. Typically, these meetings are scheduled every three to six weeks.

Therefore, attaching the appliances to a user's teeth is tedious and time-consuming enterprise and requires many meetings with the treating orthodontist.

Various methods have been proposed to simplify and to reduce the cost of orthodontics with limited success. For example, Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562, 5,395,238; 5,368,478; and 5,139,419, assigned to Ormco Corporation, describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the jaw is described in U.S. Pat. Nos. 5,342,202 and 5,340,309. Other patents of interest include U.S. Pat. Nos. 5,549,476; 5,382,164; 5,273,429; 4,936,862, 3,860,803, 3,660,900; 5,645,421; 5,055,039; 4,798,534; 4,856,991; 5,035,613; 5,059,118, 5,186,623; and 4,755,139.

FIG. 1 shows the background technology of the instant application. In FIG. 1, reference labels 1 and 2 show the labial and buccal sides or surfaces of an appliance, and reference labels 3 and 4 show the lingual side or surface of an appliance, each of the appliances comprising cavities that correspond to each tooth of a dental arch. Each of the appliance is digitally made according to a prescription by a treating doctor according to the background technology. In particular, according to the existing background technology, except for the shapes and geometries, each of the appliances is made of the same material having the same chemical, physical, mechanical, and biological parameters that, to each appliance, each wall of each cavity of each appliance is indistinguishably made of the same material and has the same thickness.

U.S. Pat. Nos. 6,398,548 and 6,554,611 describes using a computer program predict the teeth movement from initial tooth positions to the final tooth positions and design and fabricate a series of appliances having different geometries to achieve the repositioning of the teeth from their initial positions to their final positions in one set of appliances in that the user receives a whole set of appliances from the beginning to the finish. The appliances are numbered or marked in the sequence for use. The problem is that if certain tooth movement is behind the expected tooth position, the discrepancy between actual tooth position and expected (predicted) tooth position will most likely increase further and further during the course of repositioning. In addition, teeth with increased discrepancies between actual and expected positions will experience a disproportionate load of force relative to the other teeth and lead to increased patient pain and discomfort.

Another problem of current clear tooth aligners concerns oral hygiene. Oral cavity is fully of micropathogens. Prolonged use of an aligner can render it unpleasant to use.

The embodiments described below address the above identified needs and issues.

### SUMMARY OF THE INVENTION

The present utility model application provides a system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement, each of the one or more intermediate appliances having at least one identical copy; and (c) at least one final appliance having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement,

wherein the locks comprise polymeric shells having cavities shaped to receive MP teeth and cavities shaped to receive NP teeth so as to resiliently reposition teeth from one arrangement to a successive arrangement,

wherein each of the polymeric shells has a labile/buccal wall of thickness (“LBW thickness”) and a palatal/lingual wall thickness (“PLW thickness), the LBW thickness being different from the PLW thickness,

wherein the LBW thickness or PLW thickness of cavities receiving MP teeth has a thickness that is higher than that of the cavities receiving the NP teeth in the first appliance and optional one or more intermediate appliances, and

wherein the system provides specifications of the appliances to allow an orthodontic doctor to prescribe an order for the user to use the appliances based on the specifications.

In some embodiments of the system disclosed herein, each cycle of successive appliances contains a customized force system prescribed by the orthodontic doctor.

In some embodiments of the system disclosed herein, each cycles contains a de-escalating, escalating, and/or combinations of de-escalating/escalating force system.

In some embodiments of the system disclosed herein, the system comprises at least two cycles of appliances.

In some embodiments of the system disclosed herein, the system comprises at least two first appliances which are identical to each other in geometries, materials forming the appliances, and physical dimensions.

In some embodiments of the system disclosed herein, the system comprises from 2 to 20 successive appliances.

In some embodiments of the system disclosed herein, each of the appliances carries specifications to specify the differential force.

In some embodiments of the system disclosed herein, each of appliances carries specification to specify the dimension or material characteristics of the appliance.

In some embodiments of the system disclosed herein, the specification specifies the geometry or thickness of the appliances, a high, medium, or low differential force of the appliances, and/or anticipated discrepancies of the appliances.

In some embodiments of the system disclosed herein, the LBW thickness or PLW thickness of the cavities receiving MP teeth has a thickness that is from about 0.1 mm to about 2 mm higher than that of the cavities receiving the NP teeth.

In some embodiments of the system disclosed herein, either the LBW thickness or PLW thickness of the cavities receiving MP teeth has a thickness that is identical to that of the cavities receiving the NP teeth.

In some embodiments of the system disclosed herein, any of the cycles comprises two or more appliances, the subsequent appliance having a thickness that differs from the thickness of the prior appliance in the range from about 0.1 to about 2 mm.

In some embodiments of the system disclosed herein, at least a region of an individual lock or shell comprises two or more layers of a polymeric material.

In some embodiments of the system disclosed herein, at least a region of an individual lock or shell comprises a material reinforced with a structure selected from the group consisting of pieces, strips, wires, mesh, lattices, interpenetrating networks, networks and combinations thereof.

In some embodiments, to increase anchorage of the appliance, a dental implant can be used in association with the cycle of appliances. The implant can be palatally placed or buccally placed or placed on the retromolar area.

The methods of making and using the system described herein are also described.

### BRIEF DESCRIPTION OF THE DRAWINGS

FIG. 1 shows the prior art orthodontic appliances.

FIGS. 2 and 3 each show embodiments of the invention appliance having a different wall thickness in the labial/buccal wall (“LBW”) (FIG. 2, reference label 5) or palatal/lingual wall (“PLW”) (FIG. 3, reference label 6).

FIG. 4 shows an embodiment of invention method of treatment of malpositioned tooth/teeth of a subject in need thereof.

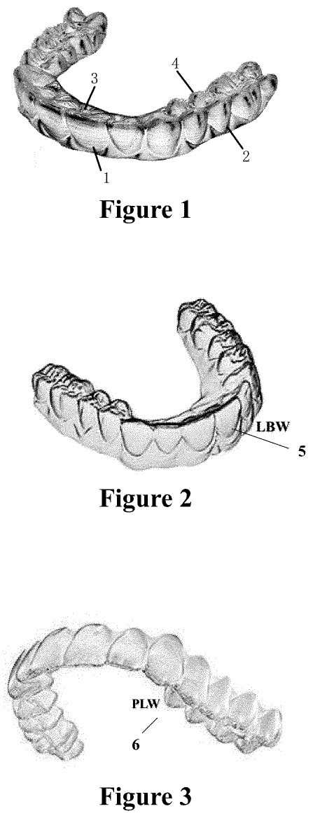

### DETAILED DESCRIPTION OF INVENTION EMBODIMENTS

Provided herein is an orthodontic force system for repositioning teeth. The system includes one or more cycles appliances capable of incrementally move the teeth from an initial tooth arrangement to the final tooth arrangement. The system allows a prescribing orthodontic doctor to evaluate a tooth arrangement during the course of treatment and to determine an optimal force application through selection of orthodontic appliances. Optimal force application as used herein is defined as an optimal balance between efficient tooth/teeth movement and patient comfort. From a practical standpoint, optimal force application can be achieved through integrating known teeth positions optimal appliance geometries and forces.

In one aspect, the system includes at least two cycles of successive appliances having geometries selected to successively move or reposition teeth from an initial position to the final position. The first cycle is formed using a digital data set obtained based on the initial tooth arrangement, and the second cycle (which can be an intermediate or the last cycle) is formed using a data set obtained based on the last tooth arrangement achieved by the first cycle or the cycle prior to the last cycle. The second cycle data set is important because it can identify and reduce or minimize discrepancies between actual and predicted positions for tooth/teeth movement. The first cycle data set can be obtained by dental impressions, oral scanners, or other modalities known to those in the art. The second cycle data set (and all other cycles beyond the first set) can be obtained by, e.g., clinical exam, dental impressions, oral scanners, or other modalities known to those in the art. The second cycle data set (and all other cycles beyond the first set) can be digital or non-digital depending on the discretion of the prescribing orthodontic doctor.

In another aspect, the system described herein includes a system of de-escalating and/or escalating forces with each appliance cycle. Each appliance cycle includes at least two appliances of varying geometries and/or forces from which the prescribing orthodontic doctor can decide if de-escalating, escalating and/or combinations of de-escalating/escalating forces are most appropriate.

Specifically, the system described herein includes a cyclic force system for repositioning teeth from an initial tooth arrangement to a final tooth arrangement. The system includes a cycle of a plurality of appliances that includes. (a) two or more appliances having a geometry selected to reposition the teeth from the same initial tooth arrangement to a same first intermediate arrangement, (b) optionally one or more intermediate appliances having geometries selected to progressively reposition the teeth from the same first intermediate arrangement to successive intermediate arrangements, each repositioning uses two or more appliances repositioning the tooth (teeth) from the same starting intermediate arrangement to the same next tooth (teeth) arrangement, and (c) two or more final appliance having a geometry selected to progressively reposition the teeth from the same last intermediate arrangement to the same final tooth arrangement. As used herein, the term “two or more” is inclusive and can include any number of appliances that is higher than one appliance, e.g., 2 appliances, 3 appliances, 4 appliances, 5 appliances, 6 appliances, 7 appliances, 8 appliances, 9 appliances, 10 appliances or more. In some embodiments, the term “two or more” can include 2-15 appliances, 2-10 appliances, or 2-5 appliances.

The appliances in the system described herein may have different forces that can be designed and tailored by varying parameters such as, but not limited to dimensions (e.g., thickness and/or geometry) and/or material characteristics.

The appliances in the system described herein may include successive locks having different geometries shaped to receive and allow the appliances to reposition teeth from one arrangement to a successive arrangement. The locks can be any mechanism capable of receiving the teeth so as to allow the appliances to incrementally move or adjust teeth from one arrangement to another. The locks can be, for example, metallic, plastic or polymeric wires, clips, rings, caves, or shells. In some embodiments, the locks specifically exclude polymeric shells.

The system described herein may provide specifications of the appliances such that an orthodontic doctor can prescribe the order of use of the appliances based on the specifications. Specifications can include, but are not limited to dimensions (e.g., force, thickness, and/or geometry) and/or material characteristics. In some embodiments, the cycles in the system can be marked to indicate the sequence of cycles. In some other embodiments, the appliances can be marked such that an orthodontic doctor can prescribe the order of using the appliances.

### Systems

Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and system s will reposition teeth in from ten to twenty-five successive steps, although complex cases involving many of the user's teeth may take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances will usually not be the same for any particular tooth.

The system includes cycles of successive appliances with different geometries that define teeth positions corresponding to different stages of treatment. The system may include only one set of two or more identical cycles of successive appliances. The system may include a multiple cycles of successive appliances; each cycle other than the final cycle is capable of moving the teeth to an intermediate position; and the final cycle is capable of moving the teeth to the final position from the last intermediate position. For example, for a two cycle system, the first cycle can move the teeth from the initial position (position 1) to an intermediate position (position 2), and the second cycle can then move the teeth from position 2 to the final position. For a three cycle system, the first cycle can move the teeth from the initial position (position 1) to the first intermediate position (position 2), the second cycle can then move the teeth from position 2 the second intermediate position (position 3), and the final cycle can move the teeth from position 3 to the final position.

In one aspect of the of present invention, the tooth repositioning system described herein comprises at least two successive appliances, e.g., about 2 to about 20 successive appliances, about 2 to about 15 successive appliances, about 2 to about 10 successive appliances, about 2 to about 8 successive appliances, about 2 to about 5 successive appliances, about 3 to about successive 20 appliances, about 3 to about successive 15 appliances, about 3 to about successive 10 appliances, about 3 to about successive 8 appliances, about 3 to about successive 5 appliances, about 4 to about successive 20 appliances, about 4 to about successive 15 appliances, about 4 to about successive 10 appliances, about 4 to about successive 8 appliances, about 4 to about successive 5 appliances, about 5 to about successive 20 appliances, about to about successive 15 appliances, about 5 to about successive 10 appliances, about 5 to about successive 8 appliances, or about successive 5 appliances.

The appliances have one or more geometries defining the positions of the teeth at the onset of the orthodontic treatment (initial positions), in the middle of the orthodontic treatment (intermediate positions), or at the completion point of the orthodontic treatment (final positions). Each of the appliances is different in terms of dimensions (e.g., force, thickness, and/or geometry) and/or material characteristics, which correspond to the torch modulus and forces that progressively move teeth from one position to another.

Systems described herein include successive appliances including at least two first appliances having a geometry selected to reposition a user's teeth from the initial tooth arrangement to a first intermediate arrangement where individual teeth will be incrementally repositioned. In some embodiments, the system further comprises at least one intermediate appliance having a geometry selective to progressively reposition teeth from the first intermediate arrangement to one or more successive intermediate arrangements including a last intermediate tooth arrangement, each of the at least one intermediate appliance includes at least one duplicate of itself. In some embodiments, the system still further comprise at least two identical final appliances having a geometry selected to progressively reposition teeth from the last intermediate arrangement to the desired final tooth arrangement. In some cases, it is desirable to form the final appliances or several appliances to “over correct” the final tooth position, as discussed in more detail below.

In some embodiments, the term “successive appliance” refers to an appliance having a geometry or geometries for repositioning a tooth or teeth from one position, which can be an initial position or an intermediate position, to another position, which can be an intermediate position or a final position. In the successive appliances in the system described herein, each successive appliance includes a geometry or geometries different from the geometry or geometries in another successive appliance.

As used herein, the term “identical appliances” refers to appliances that are identical to each other with respect to geometries, materials forming the appliances, and/or physical dimensions of the appliances. Relatedly, the term “copy” of an appliance (“parent appliance”) refers to a copy appliance of the parent appliance that is identical to the parent appliance with respect to the geometries, materials forming the appliances, and/or physical dimensions of the appliances, and, in this context, the term “duplicate appliances” is used interchangeably with the term “duplicates” or “duplicate appliances” and refers to a copy appliance of the parent appliance that is identical to the parent appliance with respect to each of the geometries, materials forming the appliances, and physical dimensions of the appliances.

In some embodiments, the system described herein can have successive appliance(s), each of which includes from 2 to 20, 2 to 15, 2 to 10, 2 to 8, or 2 to 5 identical appliances. For example, 2, 3, 4, 5, 6, 7, 8, 9, or 10 identical appliances.

As described in more detail below in connection with the methods of the of present invention, the systems is planned and all individual appliances for the first cycle fabricated at the outset of treatment, and the appliances is thus be provided to the orthodontic doctor as a single package or system. The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e.g., near zero), while the last appliance of the first cycle is expected to have a larger discrepancy (e.g., larger than zero). The exact units for the discrepancy is expressed as, but not limited to, a percentage, a metric measurement, or other numerical system (e.g., scale of 0 to 25; with 25 being maximum discrepancy). The calculation of the discrepancy can be based to varying degrees on degree of teeth movement required, the appliance dimensions, the appliance material characteristics, and the use or non-usage of anchoring devices (e.g., dental implants in bone). Upon obtaining the proper sequence of appliance usage, the user can place the appliances over his or her teeth at a frequency prescribed by the orthodontist or other treating professional. Unlike braces, the user need not visit the treating professional every time an adjustment in the treatment is made. While the users will usually want to visit their treating professionals periodically to assure that treatment is going according to the original plan, eliminating the need to visit the treating professional each time an adjustment is to be made allows the treatment to be carried out in many more, but smaller, successive steps while still reducing the time spent by the treating professional with the individual user. Moreover, the ability to use polymeric shell appliances which are more comfortable, less visible, and removable by the user, greatly improves user compliance, comfort, and satisfaction.

The individual appliances will preferably comprise a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the user, certain of the teeth will be misaligned relative to an un-deformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step. However, this accommodation or conforming to the misaligned teeth through successive appliance geometries results in increasing discrepancies between actual teeth positions and expected (predicted) teeth positions.

The anticipated discrepancy between actual teeth positions and expected (predicted) teeth positions as a result of successive changes in appliance geometry are clearly marked on the appliance along with other important dimensions and/or material characteristics useful to the prescribing orthodontic doctor. For example, the first appliance of the first cycle is expected to have a very small discrepancy (e.g., near zero), while the last appliance of the first cycle is expected to have a larger discrepancy (e.g., larger than zero). The exact units for the discrepancy is expressed as, but not limited to, a percentage, a metric measurement, or other numerical system. The calculation of the discrepancy can be based variably on the degree of teeth movement required, the appliance dimensions, the appliance material characteristics, and the use or non-usage of anchoring devices (e.g., dental implants in bone).

The individual appliances described herein also exert different forces on a tooth arrangement. The different force pertaining to each appliance is achieved by increasing thickness and rigidity while keeping the same elastic modulus or changing the material properties such as elastic modulus and stiffness while not changing the thickness or changing any combination of thickness, rigidity, elastic modulus, and/or material properties. Note, the force exerted on a given tooth or series of teeth is distinct, although somewhat dependent on the material and/or mechanical properties of the appliance. The force pertaining to the appliance is generally related to the thickness, rigidity, elastic modulus, and/or material properties of the appliance. In contract, the force exerted on a given tooth or series of teeth is generally related to the actual teeth positions and desired teeth positions, geometry of the appliance in achieving the desired teeth positions, as well as the material and/or mechanical properties of the appliance and whether any anchoring dental implant devices are employed.

In one embodiment, the system described herein includes one or more than one cycle of appliances with differential de-escalating and/or escalating force system (e.g., from high-to-low, low-to-high, high-to-high, low-to-low, high-to-low-to-high, low-to-high-to-low, etc). The combinations of de-escalating and/or escalating force systems are only limited by appliance number per cycle. For example, the system may include a first appliance with high force having a geometry selected to reposition the teeth from the initial tooth arrangement to a first intermediate arrangement, one or more intermediate appliances having geometries and reducing force system selected to progressively reposition the teeth from the first intermediate arrangement to successive intermediate arrangements, and a final appliance with lowest force system in a cycle having a geometry selected to progressively reposition the teeth from the last intermediate arrangement to an end tooth arrangement. If necessary, a new cycle of force system will start from the end tooth arrangement of the previous cycle until the whole treatment finished.

For each cycle, a description of the force systems will be provided to describe the force of each appliance and to suggest to the treating orthodontic doctor the order of using each individual appliance in predetermined differential force which will progressively move the user's teeth toward the final arrangement, a package, said package containing one cycle of appliances, wherein the appliances are provided in a single package to the user. The treating orthodontics will then provide to the user the proper order of using the appliances on the basis of each user's condition and the doctor's professional judgment and discretion.

In some embodiment, the system described herein comprises one or more than one cycle of appliances. Each cycle contains one or more appliances having a differential de-escalating and/or escalating force system as previously described. In some embodiments, each cycle of the system can be marked for the sequence of the cycles.

The different force pertaining to each appliance is made different by changing the dimension and/or material characteristics of the appliances. For example, the appliances can be made to have different thickness to generate different forces. For example, the appliances can have a thickness ranging from about 0.01 mm, about 0.1 mm, about 0.2 mm, about 0.3 mm, about 0.4 mm, about 0.5 mm, about 0.6 mm, about 0.7 mm, about 0.8 mm, about 0.9 mm, about 1 mm, about 1.1 mm, about 1.2 mm, about 1.3 mm, about 1.4 mm, about 1.5 mm, about 1.6 mm, about 1.7 mm, about 1.8 mm, about 1.9 mm or about 2.0 mm. In some other embodiments, different forces of appliances can be achieved using different material forming the appliances. For example, the material can be blended with reinforcement materials such as fibers, pieces, strips, wires, mesh, lattices, networks, interpenetrating networks, or combinations thereof to cause the appliances to have different forces.

To achieve desired speed of orthodontic treatment, the forces of individual appliances in a cycle can be tailored to meet the needs of treatment. For example, in each cycle, the subsequent appliance can be made to differ from the prior appliance stiffness, in the range from, e.g., about 0.1 to about 8 Gpa. In some embodiments, in each cycle of appliance, the prior appliance can be made to have an elastic modulus that differs from the elastic modulus of the subsequent appliance by about 1% to about 800%. In some other embodiments, in each cycle, the subsequent appliance thickness can be made to differ from the prior appliance thickness, in the range from about 0.1 to about 2 mm.

In some embodiments, the of present invention provides a system for repositioning teeth from an initial tooth arrangement to a final tooth arrangement. The system comprises one or more cycle of successive appliances, the system including:

(a) at least two identical first appliances having a geometry selected to reposition the teeth from the initial tooth arrangement to a first intermediate arrangement or the final tooth arrangement;

(b) optionally one or more intermediate appliances having geometries selected to progressively reposition the teeth from the first intermediate arrangement to successive intermediate arrangements including a last intermediate tooth arrangement, each of the one or more intermediate appliances having at least one identical copy; and

(c) at least two identical final appliances having a geometry selected to progressively reposition the teeth from the initial tooth arrangement or the last intermediate arrangement to the final tooth arrangement,

wherein the appliances comprise successive locks having different geometries shaped to receive and allow the appliances to reposition teeth from one arrangement to a successive arrangement, and

wherein the system provides specifications of the appliances such that an orthodontic doctor can prescribe the order to use the appliances based on the specifications.

The successive locks can be formed of a material that includes a metallic material, a plastic material, and/or a polymeric material. Some examples of the locks include, e.g., polymer shells, polymer rings, metal wires or clips, hard plastic clips, ceramic clips, or elastic polymeric shells or rings. In some embodiments, the locks specifically exclude polymeric shells.

In some embodiments, the appliances can be made to have different configurations to achieve different force systems. For example, the shells or rings on an appliance can have at least a region including two or more layers of a polymeric material to achieve the force system. In some embodiments, the shells or locks can be made to have uniform or non-uniform stiffness, elastic modulus, and/or thickness in part or the entire body of the shell or lock to generate the force system.

The system provided herein may be specified in the ways known in the art. For example, in a cycle, each appliance can carry specifications for the differential force, for example, specifying the dimensions of one or more appliances, such as the thickness or diameter of the appliances or the material characteristics forming the appliances, such as high, medium, or low differential force. These specifications of the appliances can be marked on each appliance or alternatively, marked on tags or by placement in a package. Some or all of the appliances in a cycle may further bear numeric marks, for example, numbers from 0 through 25 to indicate the anticipated discrepancy between actual teeth positions and expected (predicted) teeth positions as a result of successive changes in appliance geometry.

In some embodiments, to increase anchorage of the appliance, a dental implant can be used in association with the cycle of appliances. The implant can be palatally placed or buccally placed or placed on the retromolar area.

FIGS. 2 and 3 each show embodiments of the invention appliance having a different wall thickness in LBW (FIG. 2, reference label 5) or PLW (FIG. 3, reference label 6).

### Materials

The appliances can be formed of an elastic material that may include one or more polymers. The polymer is preferably inert and biocompatible. The polymer is also sufficiently flexible to allow easy removal and application for the user, but also sufficiently rigid to allow controlled teeth movement. Any conventional material normally used in dental treatments for fabricating removable appliances can be used in this system. Specific examples of useful polymers include any elastic polymeric materials, such as those commonly used in the art of dentistry, e.g., olefin polymers or copolymers, such as polyethlyene, polybutylene, polyisobutylene, polypropylene, ethylene vinyl acetate, polyvinyl alcohol, polystyrene, copolymers that include two or more of ethylene, propylene, butylene, isobutene, pentene, styene, vinyl acetate, vinyl alcohol and a combination thereof, or a mixture thereof. The polymeric material may further include a material to modify the biocompatibility. Such biocompatibility modifying materials include, e.g., polyethylene glycol, polypropylene glycol, polyethylene oxide or a natural polymer such as cellulose or alginate, collagen, and the like.

In some embodiment, the polymeric materials may further include a reinforcing material such as fibers, chips, wires, glass fibers, carbon fibers, pieces, strips, mesh, lattices, and networks and interpenetrating networks. Some representative reinforcing materials include, for example, micro or nano aluminum oxide phases, carbon fibers, etc., or mixtures thereof.

### Method of Fabrication

The system can be formed by (a) receiving prescribed orthodontic information for a user in need of orthodontic treatment, (b) forming a cycle of appliances comprising individual appliances, and (c) forming a cycle of appliances.

In one aspect, the appliances can be formed by (1) generating/obtaining an initial data set such as an initial digital data set (IDDS) representing the initial tooth arrangement, (2) generating a digital data set (DDS) or non-digital data set (NDDS) representing an intermediate tooth arrangement, (3) generating an end or a final data set such as a DDS or NDDS representing an end tooth arrangement or a final tooth arrangement, and (4) optionally producing a plurality of successive digital data sets based on both of the first digital data set and the final digital data set, wherein the plurality of successive data sets represent a series of successive tooth arrangements progressing from the intermediate tooth arrangement last end tooth arrangement to the end tooth arrangement or the final tooth arrangement, and (5) forming an appliance or a plurality of appliances based on the digital data sets. In some embodiments, the digital data sets can be converted into visual images representing a tooth arrangement, and the appliances can be formed based on the visual images. Methods of obtaining the IDDS and DDS, generating a visual image based on DDS and forming an appliance based on the visual image are described in U.S. Pat. Nos. 6,398,548; 6,544,611; 5.895.893; 6,244,861; 6,616,444; 5,645,420; and 5,447,432, the teachings of which are incorporated herein by reference.

The initial digital data set may be provided by any techniques known in the art, including digitizing X-ray images, images produced by computer-aided tomography (CAT scans), images produced by magnetic resonance imaging (MRI), images produced by photo scanning, and the like. The images will be three-dimensional images and digitization may be accomplished using known technology. For example, the initial digital data set is provided by producing a plaster cast of the user's teeth (prior to treatment) by techniques known in the art. The plaster cast so produced may then be scanned using laser or other scanning equipment to produce a high resolution digital representation of the plaster cast of the user's teeth.

In a preferred embodiment, a wax bite is also obtained from the user using standard methods. The wax bite allows plaster casts of a user's upper and lower dentition to be placed relative to one another in the centric occlusal position. The pair of casts then can be scanned to provide information on the relative position of the jaw in this position. This information is then incorporated into the IDDS for both arches.

Once the digital data set is acquired, an image can be presented and manipulated on a suitable computer system equipped with computer-aided design software, as described in greater detail below. The image manipulation will usually comprise defining boundaries about at least some of the individual teeth, and causing the images of the teeth to be moved relative to the jaw and other teeth by manipulation of the image via the computer. Methods are also provided for detecting cusp information for the teeth. The image manipulation can be done entirely subjectively, i.e. the user may simply reposition teeth in an aesthetically and/or therapeutically desired manner based on observation of the image alone. Alternatively, the computer system could be provided with rules and algorithms which assist the user in repositioning the teeth. In some instances, it will be possible to provide rules and algorithms which reposition the teeth in a fully automatic manner, i.e. without user intervention. Once the individual teeth have been repositioned, a final digital data set representing the desired final tooth arrangement will be generated and stored.

An exemplary method for determining the final tooth arrangement is for the treating professional to define the final tooth positions, e.g. by writing a prescription. The use of prescriptions for defining the desired outcomes of orthodontic procedures is well known in the art. When a prescription or other final designation is provided, the image can then be manipulated to match the prescription. In some cases, it would be possible to provide software which could interpret the prescription in order to generate the final image and thus the digital data set representing the final tooth arrangement.

In yet another aspect, methods described herein are provided for producing a plurality of digital data sets representing a series of discrete tooth arrangements progressing from an initial tooth arrangement to a final tooth arrangement. Such methods comprise providing a digital data set representing an initial tooth arrangement (which may be accomplished according to any of the techniques set forth above). A digital data set representing a final tooth arrangement is also provided. Such final digital data set may be determined by the methods described previously. A plurality of successive digital or non-digital data sets are then produced based on the initial digital data set and the final digital data set. Usually, the successive digital data sets are produced by determining positional differences between selected individual teeth in the initial data set and in the final data set and interpolating said differences Such interpolation may be performed over as many discrete stages as may be desired, usually at least three, often at least four, more often at least ten, sometimes at least twenty-five, and occasionally forty or more. Many times, the interpolation will be linear interpolation for some or all of the positional differences. Alternatively, the interpolation may be non-linear. In a preferred embodiment, non-linear interpolation is computed automatically by the computer using path scheduling and collision detection techniques to avoid interferences between individual teeth. The positional differences will correspond to tooth movements where the maximum linear movement of any point on a tooth is 2 mm or less, usually being 1 mm or less, and often being 0.5 mm or less.

Often, the user will specify certain target intermediate tooth arrangements, referred to as “key frames,” which are incorporated directly into the intermediate digital data sets. The methods of the of present invention then determine successive digital data sets between the key frames in the manner described above, e.g. by linear or non-linear interpolation between the key frames. The key frames may be determined by a user, e.g. the individual manipulating a visual image at the computer used for generating the digital data sets, or alternatively may be provided by the treating professional as a prescription in the same manner as the prescription for the final tooth arrangement.

In still another aspect, methods described herein provide for fabricating a plurality of dental incremental position adjustment appliances. Said methods comprise providing an initial digital data set, a final digital or non-digital data set, and producing a plurality of successive digital or non-digital data sets representing the target successive tooth arrangements, generally as just described. The dental appliances are then fabricated based on at least some of the digital data sets representing the successive tooth arrangements. Preferably, the fabricating step comprises controlling a fabrication machine based on the successive digital data sets to produce successive positive models of the desired tooth arrangements. The dental appliances are then produced as negatives of the positive models using conventional positive pressure or vacuum fabrication techniques. The fabrication machine may comprise a stereolithography or other similar machine which relies on selectively hardening a volume of non-hardened polymeric resin by scanning a laser to selectively harden the resin in a shape based on the digital data set. Other fabrication machines which could be utilized in the methods of the of present invention include tooling machines and wax deposition machines.

In still another aspect, methods of the of present invention for fabricating a dental appliance comprise providing a digital data set representing a modified tooth arrangement for a user. A fabrication machine is then used to produce a positive model of the modified tooth arrangement based on the digital data set. The dental appliance is then produced as a negative of the positive model. The fabrication machine may be a stereolithography or other machine as described above, and the positive model is produced by conventional pressure or vacuum molding techniques.

In a still further aspect, methods for fabricating a dental appliance described herein comprise providing a first digital data set representing a modified tooth arrangement for a user. A second digital data set is then produced from the first digital data set, where the second data set represents a negative model of the modified tooth arrangement. The fabrication machine is then controlled based on the second digital data set to produce the dental appliance. The fabrication machine will usually rely on selectively hardening a non-hardened resin to produce the appliance. The appliance typically comprises a polymeric shell having a cavity shape to receive and resiliently reposition teeth from an initial tooth arrangement to the modified tooth arrangement.

In some embodiments, the orthodontic doctor can take an imprint or scan a last intermediate tooth arrangement after the user has undergone the treatment of one or more cycles of appliances. A digital data set of the last intermediate tooth arrangement of the previous cycle thus can be obtained based on the imprint or scan. This digital data set of the last intermediate tooth arrangement of the previous cycle is then used as the initial point for generating a new set of digital data and visual images based on the new set of digital data representing one or more new intermediate tooth arrangements and a final tooth arrangement for the fabrication of a new cycle of appliances.

In some embodiments, the final tooth arrangement can be achieved with the application of two or more cycles of appliances, and each cycle of the appliances incrementally move the teeth starting from the tooth arrangement positioned by the last appliance of the previous cycle. Cycles of appliances can therefore be made according to the principles described above.

### Method of Use

According to a method of the of present invention, a user's teeth are repositioned from an initial tooth arrangement to a final tooth arrangement by placing a series of incremental position adjustment appliances in the user's mouth. Conveniently, the appliances are not affixed and the user may place and replace the appliances at any time during the procedure. The first appliance of the series will have a geometry selected to reposition the teeth from the initial tooth arrangement to a first intermediate arrangement. After the first intermediate arrangement is approached or achieved, one or more additional (intermediates appliances will be successively placed on the teeth, where such additional appliances have geometries selected to progressively reposition teeth from the first intermediate arrangement through successive intermediate arrangement(s). The treatment will be finished by placing a final appliance in the user's mouth, where the final appliance has a geometry selected to progressively reposition teeth from the last intermediate arrangement to the final tooth arrangement. The final appliance or several appliances in the series may have a geometry or geometries selected to over correct the tooth arrangement, i.e. have a geometry which would (if fully achieved) move individual teeth beyond the tooth arrangement which has been selected as the “final” Such over correction may be desirable in order to offset potential relapse after the repositioning method has been terminated, i.e. to permit some movement of individual teeth back toward their pre-corrected positions. Over correction may also be beneficial to speed the rate of correction, i.e. by having an appliance with a geometry that is positioned beyond a desired intermediate or final position, the individual teeth will be shifted toward the position at a greater rate. In such cases, treatment can be terminated before the teeth reach the positions defined by the final appliance or appliances. The method will usually comprise placing at least two additional appliances, often comprising placing at least ten additional appliances, sometimes placing at least twenty-five additional appliances, and occasionally placing at least forty or more additional appliances. Successive appliances will be replaced when the teeth either approach (within a preselected tolerance) or have reached the target end arrangement for that stage of treatment, typically being replaced at an interval in the range from 2 days to 20 days, usually at an interval in the range from 5 days to 10 days.

Often, it may be desirable to replace the appliances at a time before the “end” tooth arrangement of that treatment stage is actually achieved. It will be appreciated that as the teeth are gradually repositioned and approach the geometry defined by a particular appliance, the repositioning force on the individual teeth will diminish greatly. Thus, it may be possible to reduce the overall treatment time by replacing an earlier appliance with the successive appliance at a time when the teeth have been only partially repositioned by the earlier appliance. Thus, the FDDS can actually represent an over correction of the final tooth position. This both speeds the treatment and can offset user relapse.

In general, the transition to the next appliance can be based on a number of factors. Most simply, the appliances can be replaced on a predetermined schedule or at a fixed time interval (i.e. number of days for each appliance) determined at the outset based on an expected or typical user response. Alternatively, actual user response can be taken into account, e.g. a user can advance to the next appliance when that user no longer perceives pressure on their teeth from a current appliance, i.e. the appliance they have been wearing fits easily over the user's teeth and the user experiences little or no pressure or discomfort on his or her teeth. In some cases, for users whose teeth are responding very quickly, it may be possible for a treating professional to decide to skip one or more intermediate appliances, i.e. reduce the total number of appliances being used below the number determined at the outset. In this way, the overall treatment time for a particular user can be reduced.

In another aspect, methods of the of present invention comprise repositioning teeth using appliances comprising polymeric shells having cavities shaped to receive and resiliently reposition teeth to produce a final tooth arrangement. The of present invention provides improvements to such methods which comprise determining at the outset of treatment geometries for at least three of the appliances which are to be worn successively by a user to reposition teeth from an initial tooth arrangement to the final tooth arrangement. Preferably, at least four geometries will be determined in the outset, often at least ten geometries, Frequently at least twenty-five geometries, and sometimes forty or more geometries Usually, the tooth positions defined by the cavities in each successive geometry differ from those defined by the prior geometry by no more than 2 mm, preferably no more than 1 mm, and often no more than 0.5 mm, as defined above.

The system can be used to treat or prevent orthodontic conditions such as malalignment, crowding, spacing, overjet, overbite problem, and a combination thereof.

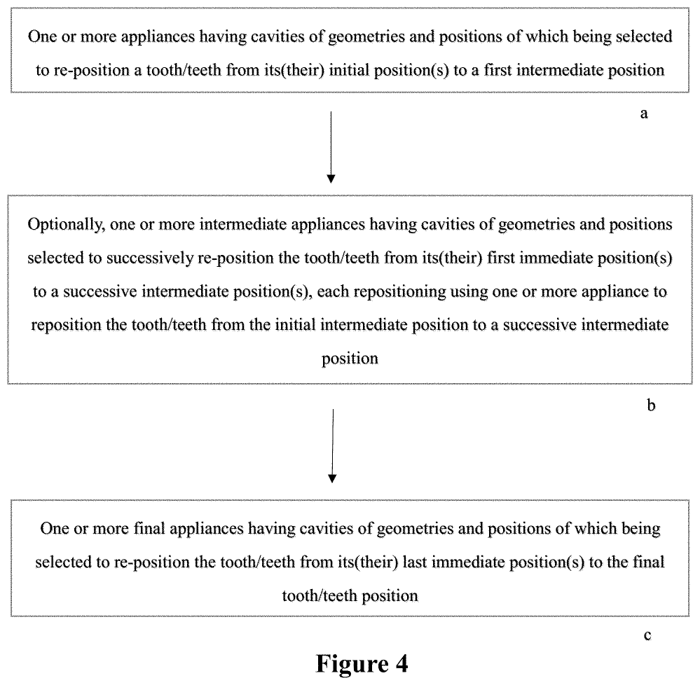

Referring to FIG. 4, in step a, the invention system comprises one or more appliances having cavities and geometries selected to reposition a tooth/teeth from its (their) initial position(s) to a first intermediate position(s) (step a). In step b, optionally, one or more intermediate appliances have cavities of the geometries and positions selected to successively re-position the tooth/teeth from its(their) first immediate position(s) to a successive intermediate position(s), each repositioning using one or more appliance to reposition the tooth/teeth from the initial intermediate position to a successive intermediate position. In step c, One or more final appliances having cavities of geometries and positions of which being selected to re-position the tooth/teeth from its(their) last immediate position(s) to the final tooth/teeth position.

While the above is a complete description of the preferred embodiments of the system, various alternatives, modifications, and equivalents may be used. Therefore, the above description should not be taken as limiting the scope of the system which is defined by the appended claims.

I claim:

1. A system for repositioning teeth of a user in need thereof from an initial tooth arrangement to a final tooth arrangement, the user having a dental arch that comprises malpositioned (“MP”) teeth and normal-positioned (“NP”) teeth, the system comprising one or more cycles of successive appliances, each cycle of successive appliances including: (a) at least one first appliance having a geometry selected to reposition the teeth from the initial tooth arrangement to a first intermediate arrangement or the final tooth arrangement; (b) optionally one or more intermediate appliances having geometries selected to progressively reposition the teeth from the first intermediate arrangement to successive intermediate arrangements including a last intermediate tooth arrangement, each of the one or more intermediate appliances having at least one identical copy; and (c) at least one final appliance having a geometry selected to progressively reposition the teeth from the initial tooth arrangement or the last intermediate arrangement to the final tooth arrangement,
wherein the appliances comprise successive locks having different geometries shaped to receive and allow the appliances to reposition teeth from one arrangement to a successive arrangement,
wherein the locks comprise polymeric shells having cavities shaped to receive MP teeth and cavities shaped to receive NP teeth so as to resiliently reposition teeth from one arrangement to a successive arrangement,
wherein each of the polymeric shells has a labile/buccal wall of thickness (“LBW thickness”) and a palatal/lingual wall thickness (“PLW thickness), the LBW thickness being different from the PLW thickness,
wherein the LBW thickness or PLW thickness of cavities receiving MP teeth has a thickness that is higher than that of the cavities receiving the NP teeth in the first appliance and optional one or more intermediate appliances, and
wherein the system provides specifications of the appliances to allow an orthodontic doctor to prescribe an order for the user to use the appliances based on the specifications.

2. The system of claim 1, wherein each cycle of successive appliances contains a customized force system prescribed by the orthodontic doctor.

3. The system of claim 1, wherein each cycles contains a de-escalating, escalating, and/or combinations of de-escalating/escalating force system.

4. The system of claim 1, comprising at least two cycles of appliances.

5. The system of claim 1, comprising at least two first appliances which are identical to each other in geometries, materials forming the appliances, and physical dimensions.

6. The system of claim 1, comprising from 2 to 20 successive appliances.

7. The system of claim 1, wherein each of the appliances carries specifications to specify the differential force.

8. The system of claim 1, wherein each of appliances carries specification to specify the dimension or material characteristics of the appliance.

9. The system of claim 1, wherein the specification specifies the geometry or thickness of the appliances, a high, medium, or low differential force of the appliances, and/or anticipated discrepancies of the appliances.

10. The system of claim 1, wherein the LBW thickness or PLW thickness of the cavities receiving MP teeth has a thickness that is from about 0.1 mm to about 2 mm higher than that of the cavities receiving the NP teeth.

11. The system of claim 1, wherein either the LBW thickness or PLW thickness of the cavities receiving MP teeth has a thickness that is identical to that of the cavities receiving the NP teeth.

12. The system of claim 1, where any of the cycles comprises two or more appliances, the subsequent appliance having a thickness that differs from the thickness of the prior appliance in the range from about 0.1 to about 2 mm.

13. The system of claim 1, wherein at least a region of an individual lock or shell comprises two or more layers of a polymeric material.

14. The system of claim 1, wherein at least a region of an individual lock or shell comprises a material reinforced with a structure selected from the group consisting of pieces, strips, wires, mesh, lattices, interpenetrating networks, networks and combinations thereof.
